(19) United States
(12) Patent Application Publication
(10) Pub. No.: US 2025/0321100 A1
(43) Pub. Date: Oct. 16, 2025

(54) INSTRUMENT FOR DETERMINING LEVEL, PLUMB, AND 45-DEGREE ORIENTATIONS

(71) Applicant: Thomas Costello, Covina, CA (US)

(72) Inventor: Thomas Costello, Covina, CA (US)

(21) Appl. No.: 18/634,815

(22) Filed: Apr. 12, 2024

(51) Int. Cl. G01C 9/36; G01C 25/00

(52) U.S. Cl. CPC G01C 9/36; G01C 25/00

(57) ABSTRACT

An instrument for determining level, plumb, and 45-degree orientations includes an elongated body having a plurality of orientation indicators, wherein each of the orientation indicators is capable of indicating level, plumb, and 45-degree orientation in accordance with the current position of the elongated body. The instrument further includes a calibration mechanism for re-calibrating the orientation indicators.

### FIELD OF INVENTION

The present invention relates generally to leveling instruments, and more specifically to an improved design and functionality of a level stick, also known as a bubble level or spirit level.

### BACKGROUND

A level, often known as a bubble or spirit level, is a tool used to identify if a surface or line is horizontally straight. Traditional levels consist of an elongated body, within which are horizontal, sealed cylindrical tubes partially filled with a liquid such as alcohol. Each of these tubes contains an air bubble. When the level is positioned on a flat surface, these air bubbles center themselves within the tubes. Typically, two indicator lines surround this central position; if the air bubble is between them, it indicates the surface or line is level.

Besides horizontal measurements, many levels have vertically oriented tubes similar in design to the horizontal ones. These vertical tubes help determine if a surface is plumb, meaning it's perpendicular to the ground. When the level is held vertically against a surface or along a plumb line, the air bubble will center itself if the surface or line is perfectly vertical. These vertical tubes also typically have pairs of indicator lines for reference. Additionally, some levels feature tubes set at a 45-degree angle to ascertain if a surface or line has a 45-degree inclination.

Levels have been familiar tools for many years. For instance, a traditional level made of aluminum that contains separate tubes for level and plumb measurements was patented in the U.S. by Rasey in 1915 U.S. Pat. No. 1,128,361. While these conventional levels are generally effective, they have limitations. For instance, they use distinct tubes to measure either level or plumb, meaning a single tube can't measure both. Consequently, most of these levels feature three tubes: two horizontal and one vertical. This design can be cumbersome, especially for vertical measurements since only one tube assesses plumb. Additionally, having to include multiple tubes can increase manufacturing costs for those seeking a singular device to measure both orientations.

### SUMMARY

The present disclosure envisages an instrument for determining level, plumb, and 45-degree orientations. The instrument comprises an elongated body including a plurality of orientation indicators, wherein each of the orientation indicators is capable of indicating at least one level, plumb, and 45-degree orientation in accordance with the position of the elongated body.

In an embodiment, the elongated body includes a front face, a rear face, a top face, a bottom face, a left lateral face, and a right lateral face.

In another embodiment, the instrument further comprises a first set of openings provided on the front and rear faces of the elongated body for facilitating embedding of the plurality of orientation indicators therein and also facilitating viewing of the orientation indicators therefrom. A second set of openings is provided on the top and bottom faces for facilitating viewing of the orientation indicators therefrom. A third set of openings is provided on the left and right lateral faces for facilitating viewing of the orientation indicators therefrom.

In another embodiment, the orientation indicator includes a chamber that has a substantially octagonal configuration defined by a pair of opposed horizontal edges, a pair of opposed vertical edges, a first pair of opposed inclined edges, a second pair of opposed inclined edges, a front convex face and a rear convex face connected to form the chamber.

In another embodiment, the chamber includes a bubble that provides an indication of orientation, wherein the bubble can be viewed from at least one of the first, second, and third sets of openings.

In another embodiment, when the elongated body is placed horizontally on a substantially level surface, the bubble will travel to the approximate highest central point of the chamber relative to the ground.

In another embodiment, when the elongated body is placed vertically on a substantially plumb surface, the bubble will travel to the approximate highest central point of the chamber relative to the ground.

In another embodiment, when the elongated body is placed on a 45-degree inclined surface, the bubble will travel to the approximate highest central point of the chamber relative to the ground.

In another embodiment, the highest central point is reached when the elongated body is placed horizontally on a substantially level surface, the highest central point of the chamber when the elongated body is placed vertically on a substantially plumb surface, and the highest central point of the chamber when the elongated body is placed on a 45-degree inclined surface are different.

In another embodiment, the highest central point reached when the elongated body is placed horizontally on a substantially level surface is positioned at about a 90-degree arc from the highest central point of the chamber when the elongated body is placed vertically on a substantially plumb surface.

In another embodiment, when the elongated body is placed on its side with the front or rear of the elongated body facing upwards on a substantially level surface, the bubble will travel to the approximate middle point of the chamber.

In another embodiment, the chamber includes a plurality of indicator lines provided on the pair of opposed horizontal edges, the pair of opposed vertical edges, the first pair of opposed inclined edges, and the second pair of opposed inclined edges for providing an indication of level, plumb, and 45-degree orientations based on the positioning of the bubble with respect to the plurality of indicator lines.

In another embodiment, the plurality of indicator lines further includes sets of three parallel lines provided on the pair of opposed horizontal edges, the pair of opposed vertical edges, the first pair of opposed inclined edges, and the second pair of opposed inclined edges.

In another embodiment, the chamber includes a central indicator on each of the front and rear sides of the chamber represented as a bullseye.

In another embodiment, the elongated body includes at least three of the orientation indicators.

In another embodiment, the instrument further comprises at least one calibration mechanism for re-calibrating the orientation indicators.

In another embodiment, the at least one calibration mechanism comprises an adjustment screw provided on the top face of the elongated body to interface with the orientation indicator and a spring disposed operatively between the bottom face of the elongated body and the orientation indicator, to facilitate pivotal movement of the orientation indicator about a pivot point for enabling the recalibration of the orientation indicator.

In another embodiment, the at least one calibration mechanism comprises an adjustment screw provided on the top face of the elongated body to interface with the orientation indicator and a pair of opposing magnets disposed operatively between the bottom face of the elongated body and the orientation indicator, to facilitate pivotal movement of the orientation indicator about a pivot point for enabling the recalibration of the orientation indicator.

In another embodiment, the at least one calibration mechanism comprises a setscrew provided on the top face of the elongated body structured to allow upward/downward movement of the orientation indicator to facilitate pivotal movement of the orientation indicator about a pivot point for enabling the recalibration of the orientation indicator.

### BRIEF DESCRIPTION OF THE DRAWINGS

FIG. 1A shows a front view of an example instrument for determining level, plumb, and 45-degree orientations placed upright on a horizontal surface to determine whether the surface is level, according to an embodiment.

FIG. 1B shows a top view of the example instrument for determining level, plumb, and 45-degree orientations shown in FIG. 1A.

FIG. 1C shows a top view of the example instrument for determining level, plumb, and 45-degree orientations of FIG. 1A placed so that the front is facing upward, on the horizontal surface to determine whether the surface is level.

FIG. 1D shows a front view of the example instrument for determining level, plumb, and 45-degree orientations placed against a vertical surface to determine whether the surface is plumb.

FIG. 1E shows a top view of the example instrument for determining level, plumb, and 45-degree orientations as positioned in FIG. 1D.

FIG. 2A shows a front view of an example orientation indicator useable with the instrument for determining level, plumb, and 45-degree orientations, according to a first embodiment of the disclosure.

FIG. 2B shows a top view of the example orientation indicator of FIG. 2A.

FIG. 3 shows a front view of an example orientation indicator useable, according to another embodiment of the disclosure.

FIG. 4A shows a schematic view of a calibration mechanism used in the instrument for determining level, plumb, and 45-degree orientations, according to a first embodiment of the present disclosure.

FIG. 4B shows a schematic view of a calibration mechanism used in the instrument for determining level, plumb, and 45-degree orientations, according to a second embodiment of the present disclosure.

FIG. 4C shows a schematic view of a calibration mechanism used in the instrument for determining level, plumb, and 45-degree orientations, according to a third embodiment of the present disclosure.

### DETAILED DESCRIPTION

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

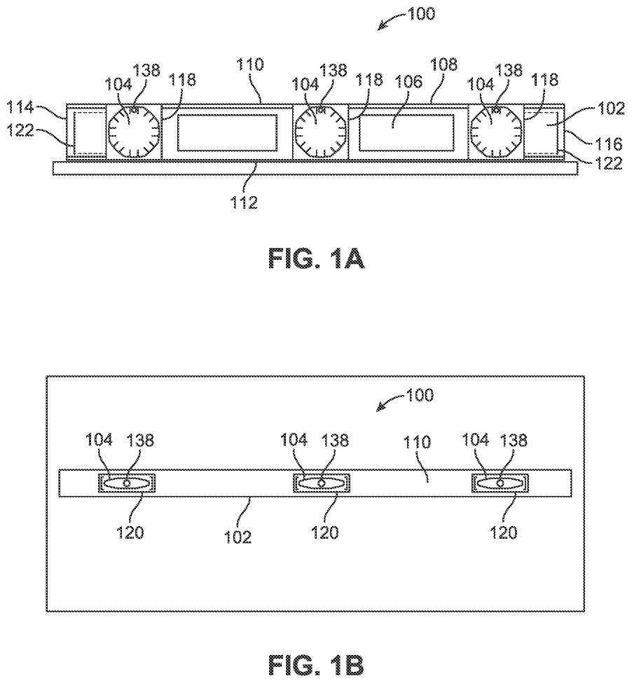

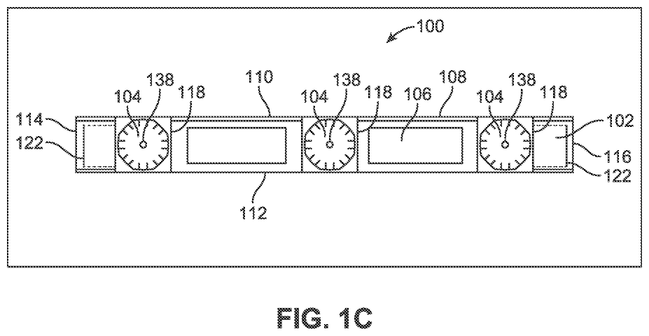

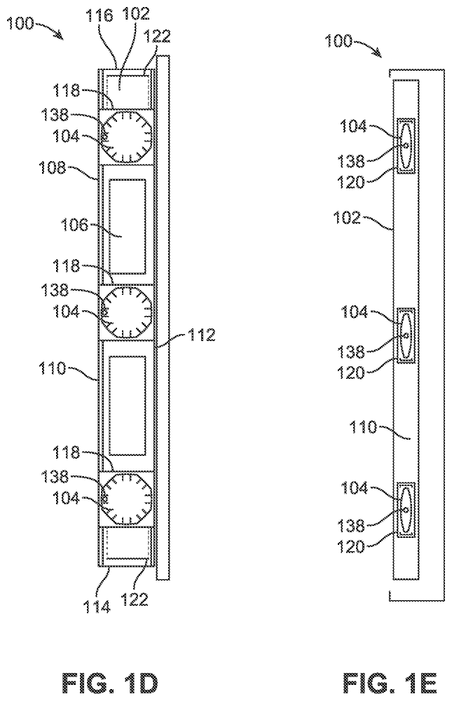

Referring to FIG. 1A, a front view of an example instrument for determining level, plumb, and 45-degree orientations 100 (hereinafter referred to as instrument 100) placed upright on a horizontal surface to determine whether the surface is level, is illustrated. The instrument 100 comprises an elongated body 102 that includes a plurality of orientation indicators 104. In an embodiment, the elongated body 102 includes at least three of the orientation indicators 104. The elongated body 102 is characterized by a front face 106, a rear face 108, a top face 110, a bottom face 112, a left lateral face 114, and a right lateral face 116. In accordance with an embodiment of the present disclosure, the elongated body 102 can be made of a suitable durable material, preferably extruded aluminum, stainless steel, or a rigid plastic such as ABS (acrylonitrile butadiene styrene). FIG. 1B is a top view thereof.

The elongated body 102 is further equipped with a first set of openings 118 provided on the front face 106 and the rear face 108. These openings 118 are designed to facilitate the embedding of the plurality of orientation indicators 104 therein, and also to facilitate viewing of the orientation indicators 104 therefrom. A second set of openings 120, as seen in FIG. 1B, is provided on the top face 110 and the bottom face 112 for facilitating viewing of the orientation indicators 104 therefrom. The operation of the orientation indicators is explained in the subsequent sections of the present disclosure. A third set of openings 122, as seen in FIG. 1A, is provided on the left lateral face 114 and the right lateral face 116 for facilitating viewing of the orientation indicators 104 therefrom. As such, the openings 118, 120, 122 facilitate the viewing of the orientation indicators from all directions for the purpose of gauging the orientation of a surface. It is to be understood that the rear face 108 of the instrument 100, which is not shown, is a mirror image of the front face 106. Furthermore, the bottom face 112 of the instrument 100, which is not shown, is a mirror image of the top face 110.

Referring to FIG. 1C, a top view of the example instrument 100 placed so that the front is facing upward, on the horizontal surface to determine whether the surface is level, is illustrated. This aspect of the instrument 100 is explained in more detail in the subsequent sections of the present disclosure.

Referring to FIG. 1D, a front view of the example instrument 100 placed against a vertical surface to determine whether the surface is plumb, is illustrated. FIG. 1E shows a top view of the example instrument 100 as positioned in FIG. 1D. This aspect of the instrument 100 is explained in more detail in the subsequent sections of the present disclosure.

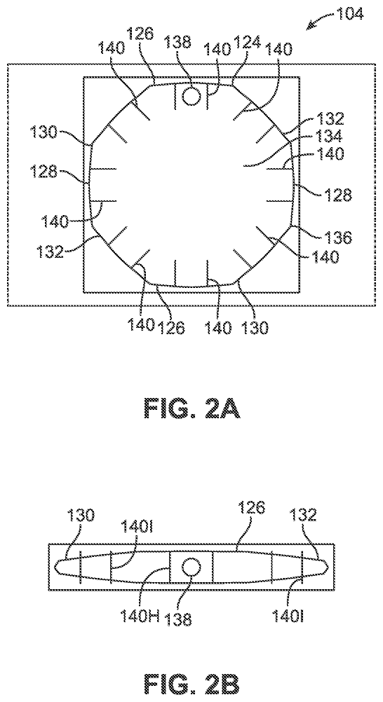

Referring to FIG. 2A, a front view of an example orientation indicator 104 useable with the instrument 100, is illustrated. Referring to FIG. 2B, a cross-sectional view of the example orientation indicators 104 along lines 2-2 of FIG. 2A, is illustrated. Each orientation indicator 104 includes a chamber 124 that has a substantially octagonal configuration. The chamber 124 is defined by a pair of opposed horizontal edges 126, a pair of opposed vertical edges 128, a first pair of opposed inclined edges 130, a second pair of opposed inclined edges 132, a front convex face 134, and a rear convex face 136 connected to form the chamber 124. In an embodiment, the chamber 124 can be made from glass, borosilicate glass, quartz, acrylic materials, polycarbonates, and so on. It is to be noted that the chamber 124 has to be made of a transparent material, in accordance with the preferred embodiment of the present invention.

As seen in FIG. 2A, the chamber 124 further includes a bubble 138 that provides an indication of orientation. The bubble 138 can be viewed from at least one of the first set of openings 118, the second set of openings 120, and the third set of openings 122. More specifically, the chamber 124 is filled with a liquid like water or alcohol, and the bubble 138 in the chamber 124 can be used in combination with appropriately configured indicator lines as an indication means for indicating the orientation of a surface. As will be discussed in subsequent sections, the instrument 100 is configured to display level, plumb, and 45-degree orientation indications using the orientation indicator 104 having the chamber 124.

The chamber 124 includes the plurality of indicator lines 140 provided on the pair of opposed horizontal edges 126, the pair of opposed vertical edges 128, the first pair of opposed inclined edges 130, and the second pair of opposed inclined edges 132 for providing indication of level, plumb, and 45-degree orientations based on positioning of the bubble 138 with respect to the plurality of indicator lines 140. In an embodiment, as seen in FIG. 2A, the plurality of indicator lines 140 can be provided as a pair of indicator lines spaced apart from each other.

When the elongated body 102 is placed horizontally on a substantially level surface, the bubble 138 will travel to an approximate highest central point of the chamber 124 relative to the ground. This central point can be seen in FIG. 2A as the position of the bubble 138 on the horizontal edge 126 between the indicator lines 140. Similarly, when the elongated body 102 is placed vertically on a substantially plumb surface, the bubble 138 will travel to the approximate highest central point of the chamber 124 relative to the ground. The gauging of the plumb orientation using the instrument 100 can be seen in FIGS. 1D and 1E. The position of the bubble 138 will be substantially central on the vertical edge 128 and between the indictor lines when the orientation is plumb. Furthermore, when the elongated body 102 is placed on a 45-degree inclined surface, the bubble 138 will travel to the approximate highest central point of the chamber 124 relative to the ground and between the indicator lines provided on the inclined edge 132.

Referring to FIG. 2B, a top view of the orientation indicator 104, is illustrated. As seen in FIG. 2B, the 3 pairs of indicator lines 140 can be seen when the orientation indicator is viewed from the top. More specifically, FIG. 2B depicts the view when the orientation indicator 104 is viewed from the second set of openings 120 provided on the top and bottom faces 110, 112 of the elongated body 102. The indicator lines 140H are configured on the horizontal edge 126, while the indicator lines 140I are configured on the inclined edges 130, 132. The indicator lines 140H can provide an indication of level orientation, while the indicator lines 140I can provide an indication of 45-degree orientation.

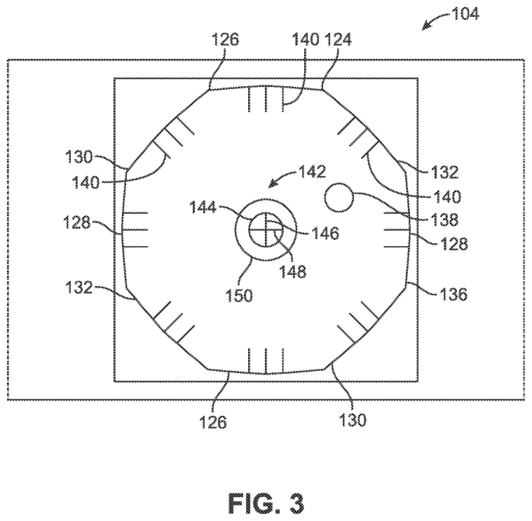

Referring to FIG. 3, a front view of an example orientation indicator useable, according to another embodiment of the disclosure, is illustrated. As seen in FIG. 3, the indicator lines 140 further include sets of three parallel lines provided on the pair of opposed horizontal edges 126, the pair of opposed vertical edges 128, the first pair of opposed inclined edges 130, and the second pair of opposed inclined edges 132.

In the instant embodiment, the chamber 124 includes a central indicator 142 on each of the front face 134 and the rear face 136 of the chamber 124 represented as a bullseye target. As shown, the bullseye target 142 includes an inner target circle 144, a center target crosshatch including perpendicular intersecting vertical and horizontal lines 146, 148, such that the vertical and horizontal lines 146, 148 extend between opposing points of the inner target circle 144, such that an intersection point of the vertical and horizontal lines 146, 148 is in the center of the inner target circle 144; and an outer target circle 150, which is symmetrically positioned around the inner target circle 144, such that inner target circle 144 and the outer target circle 150 are coaxial. It is to be understood that the illustrated bullseye target 142 is shown having a particular non-limiting pattern and that other bullseye designs and the like may be used instead of the one shown. The bullseye target 142 can be used, for example, to indicate that the air bubble 138 is at the approximate center of the rear and front convex sides of the chamber 124 to show a level orientation, such as when the instrument for determining level or plumb orientations 100 is positioned as in FIG. 1C.

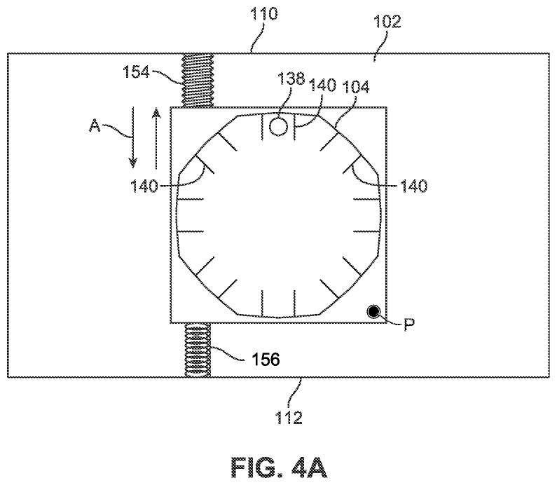

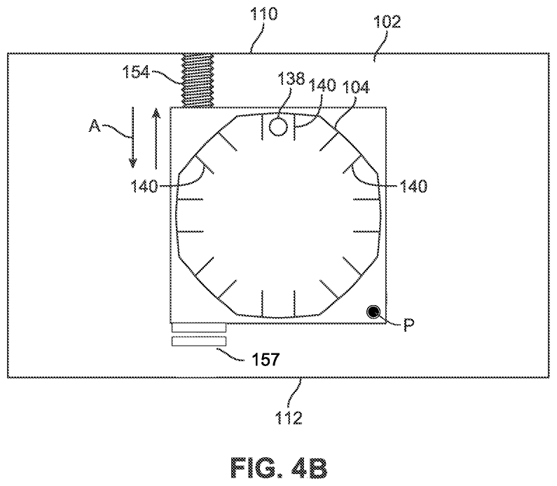

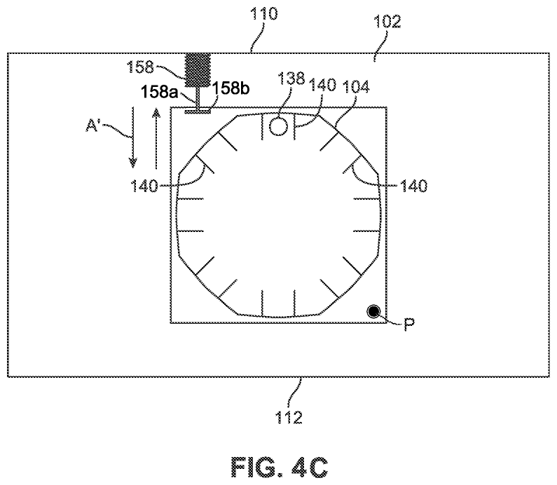

Referring to FIG. 4A, a schematic view of a calibration mechanism used in the instrument 100, according to a first embodiment of the present disclosure, is illustrated. The instrument 100 further comprises at least one calibration mechanism 152 for re-calibrating the orientation indicators 104. In the present embodiment, every orientation indicator 104 has a corresponding calibration mechanism 152. In accordance with the instant embodiment, the calibration mechanism 152 comprises an adjustment screw 154 provided on the top face 110 of the elongated body 102 to interface with the orientation indicator 104; and a spring 156 disposed operatively between the bottom face 112 of the elongated body 102 and the orientation indicator 104. Both the adjustment screw 154 and the spring 156 are offset from the center of the orientation indicator 104 near a side thereof. The calibration mechanism 152 can be used to finetune and recalibrate the positioning of the bubble 138 with respect to the indicator lines 140 by facilitating the movement of the orientation indicator 104 about a pivot point P situated near an opposite side. The pivot point P can be realized by a pin or the like received through a hole penetrating into the body of the orientation indicator 104 allowing rotation thereof.

Referring to FIG. 4B, a schematic view of a calibration mechanism used in the instrument 100, according to a second embodiment of the present disclosure, is illustrated. The instrument 100 further comprises at least one calibration mechanism 152 for re-calibrating the orientation indicators 104. In the present embodiment, every orientation indicator 104 has a corresponding calibration mechanism 152. In accordance with the instant embodiment, the calibration mechanism 152 comprises an adjustment screw 154 provided on the top face 110 of the elongated body 102 to interface with the orientation indicator 104; and a pair of repelling magnets 157 disposed operatively between the bottom face 112 of the elongated body 102 and the orientation indicator 104. Both the adjustment screw 154 and the pair of repelling magnets 157 are offset from the center of the orientation indicator 104 near a side thereof. The pair of repelling magnets 157 can include a first permanent magnet and a second permanent magnet facing each other such that a pole of the first magnet and a pole of the second magnet have the same polarity (i.e., both facing poles are North or both are South). The calibration mechanism 152 can be used to finetune and recalibrate the positioning of the bubble 138 with respect to the indicator lines 140 by facilitating the movement of the orientation indicator 104 about a pivot point P near an opposite side. The pivot point P can be realized by a pin or the like received through a hole penetrating into the body of the orientation indicator 104 allowing rotation thereof.

Referring to FIG. 4C, a schematic view of a calibration mechanism used in the instrument 100, according to a third embodiment of the present disclosure, is illustrated. In this embodiment, the adjustment screw 154 and the spring 156 (or the repelling magnets 157) are instead replaced by a modified adjustment screw 158 that includes an attachment cap 158b attached to the body of the modified adjustment screw 158 by a joining part 158a. The attachment cap 158b can be fitted into the body of the orientation indicator 104, as shown. The modified adjustment screw 158 can be fabricated by lathing a cylindrical piece or set screw such that a portion is removed forming the joining part 158a, for example. However, it is to be understood that various other techniques to form the modified adjustment screw 158 can be used. The modified adjustment screw 158 is offset from the center of the orientation indicator 104 near a side thereof. The modified adjustment screw 158 includes threading, as shown, and turning the modified adjustment screw 158 can either push the corner of the orientation indicator 104 downward or lift it upward, depending on direction of the turning. The calibration mechanism 152 can be used to finetune and recalibrate the positioning of the bubble 138 with respect to the indicator lines 140 by facilitating the movement of the orientation indicator 104 about a pivot point P near an opposite side. The pivot point P can be realized by a pin or the like received through a hole penetrating into the body of the orientation indicator 104 allowing rotation thereof.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An instrument for determining level, plumb, and 45-degree orientations, comprising:
an elongated body including a plurality of orientation indicators;
wherein each of the orientation indicators is capable of indicating level, plumb, and 45-degree orientations of a position of the elongated body.

2. The instrument according to claim 1, wherein the elongated body includes a front face, a rear face, a top face, a bottom face, a left lateral face, and a right lateral face.

3. The instrument according to claim 2, further comprising:
a first set of openings provided on the front and rear faces of the elongated body for facilitating embedding of the plurality of orientation indicators therein and also facilitating viewing of the orientation indicators therefrom;
a second set of openings provided on the top and bottom faces for facilitating viewing of the orientation indicators therefrom; and
a third set of openings provided on the left and right lateral faces for facilitating viewing of the orientation indicators therefrom.

4. The instrument according to claim 3, wherein the orientation indicator includes a chamber that has a substantially octagonal configuration defined by a pair of opposed horizontal edges, a pair of opposed vertical edges, a first pair of opposed inclined edges, a second pair of opposed inclined edges, a front convex face and a rear convex face connected to form the chamber.

5. The instrument according to claim 4, wherein the chamber includes a bubble that provides an indication of orientation, wherein the bubble can be viewed from at least one of the first, second, and third set of openings.

6. The instrument according to claim 5, wherein, when the elongated body is placed horizontally on a substantially level surface, the bubble will travel to an approximate highest central point of the chamber relative to the ground.

7. The instrument according to claim 6, wherein, when the elongated body is placed vertically on a substantially plumb surface, the bubble will travel to the approximate highest central point of the chamber relative to the ground.

8. The instrument according to claim 7, wherein, when the elongated body is placed on a 45-degree inclined surface, the bubble will travel to the approximate highest central point of the chamber relative to the ground.

9. The instrument according to claim 8, wherein:
the highest central point reached when the elongated body is placed horizontally on a substantially level surface,
the highest central point of the chamber when the elongated body is placed vertically on a substantially plumb surface, and
the highest central point of the chamber when the elongated body is placed on a 45-degree inclined surface are different.

10. The instrument according to claim 9, wherein the highest central point reached when the elongated body is placed horizontally on a substantially level surface is positioned at about a 90-degree arc from the highest central point of the chamber when the elongated body is placed vertically on a substantially plumb surface.

11. The instrument according to claim 9, wherein, when the elongated body is placed on its side with a front or rear of the elongated body facing upwards on a substantially level surface, the bubble will travel to the approximate middle point of the chamber.

12. The instrument according to claim 5, wherein the chamber includes a plurality of indicator lines provided on the pair of opposed horizontal edges, the pair of opposed vertical edges, the first pair of opposed inclined edges, and the second pair of opposed inclined edges for providing indication of level, plumb, and 45-degree orientations based on positioning of the bubble with respect to the plurality of indicator lines.

13. The instrument according to claim 12, wherein the plurality of indicator lines further include sets of three parallel lines provided on the pair of opposed horizontal edges, the pair of opposed vertical edges, the first pair of opposed inclined edges, and the second pair of opposed inclined edges.

14. The instrument according to claim 5, wherein the chamber includes a central indicator on each of the front and rear sides of the chamber represented as a bullseye.

15. The instrument according to claim 1, wherein the elongated body includes at least three of the orientation indicators.

16. The instrument according to claim 5, further comprising at least one calibration mechanism for re-calibrating the orientation indicators.

17. The instrument according to claim 16, wherein at least one calibration mechanism comprises:
an adjustment screw provided on the top face of the elongated body to interface with the orientation indicator; and
a spring disposed operatively between the bottom face of the elongated body and the orientation indicator.

18. The instrument according to claim 16, wherein at least one calibration mechanism comprises:
an adjustment screw provided on the top face of the elongated body to interface with the orientation indicator; and
a pair of repelling magnets disposed operatively between the bottom face of the elongated body and the orientation indicator.

19. The instrument according to claim 16, wherein at least one calibration mechanism comprises:
an adjustment screw provided on the top face of the elongated body to interface with the orientation indicator to facilitate pivotal movement of the orientation indicator about a pivot point for enabling the recalibration of the orientation indicator.
